(19) United States
(12) Patent Application Publication
(10) Pub. No.: US 2004/0246382 A1
(43) Pub. Date: Dec. 9, 2004

(54) Wireless device with remote control function

(76) Inventor: Chien-Chih Liu, Hsinchu City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/846,758

(22) Filed: May 14, 2004

(30) Foreign Application Priority Data
May 19, 2003 (TW) 92113439

(51) Int. Cl. H04N 5/44

(52) U.S. Cl. 348/734; 340/825.72

(57) ABSTRACT

A wireless device with a remote control function. The wireless device comprises a wired I/O port, a switching circuit, a storage device, and a remote control circuit. The switching circuit, coupled with the wired I/O port, selectively operating in an audio mode or a data mode for inputing/outputing from the wired port. A set of control codes of an external electronic device is input into the storage device for storage through the wired I/O port in the data mode. When the wireless device is in a remote control mode, the remote control circuit reads out the set of control codes from the storage device and converts the set of control codes into a wireless signal to be transmitted through an antenna, and thereby the wireless device remotely controls the external electronic device in the remote control mode.

### BACKGROUND OF THE INVENTION

1. Field of the Invention

The present invention relates to a wireless device with a remote control function, and in particular to a wireless device with a remote control function, comprising a wired I/O (Input/Output) port, a switching circuit, a storage device, and a remote control circuit.

2. Description of the Related Art

Many electronic products, such as televisions, air conditioners, and stereo systems, can be operated via remote control. Each product, however, requires a separate remote control, which may be considered inconvenient.

Most remote controls utilize infrared to transmit a set of control codes. Infrared, however, has some disadvantages. For example, infrared can neither travel a long distance nor pass through obstacles. Additionally, the receiver of an electronic product must be substantially aligned with the transmitter of a remote control thereof.

To address the disadvantages of the conventional remote control, the present invention provides a wireless device with improved remote control capability. Presently, wireless devices, such as mobile phones, are in common use. Most wireless devices comprise an IC (Integrated Circuit) with comparable computation capability and a RF (Radio Frequency) circuit for RF signal transmission. Thus, wireless devices can serve as appropriate substitutes for conventional remote controls.

### SUMMARY OF THE INVENTION

Accordingly, the present invention provides a wireless device with a remote control function, comprising a wired I/O (Input/Output) port, a switching circuit, a storage device, and a remote control circuit, wherein a set of control codes of an external electronic device is input into the storage device to be stored through the wired I/O port and the switching circuit, and the remote control circuit reads out the set of control codes from the storage device and converts the codes into a wireless signal for transmission via an antenna, thereby the wireless device can remotely control the external electronic device.

The present invention additionally provides a wireless device with a remote control function, comprising a wired I/O port, a switching circuit, a storage device, and a remote control circuit, wherein the switching circuit, coupled with the wired I/O port, selectively operating in an audio mode or a data mode for inputing/outputing from the wired port, a set of control codes of an external electronic device is input into the storage device to be stored through the wired I/O port in the data mode, the storage device stores the set of control codes transmitted from the switching circuit, and the remote control circuit reads out the set of control codes and converts the codes into a wireless signal to be transmitted to the external electronic device, thereby the wireless device can remotely control the external electronic device in a remote control mode.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a schematic diagram of a wireless device with a remote control function according to a first embodiment of the present invention.

FIG. 2 is a schematic diagram of a wireless device with a remote control function according to a second embodiment of the present invention.

FIG. 3 is a schematic diagram showing a look-up table of the control codes of a television controlled by a wireless device with a remote control function according to the second embodiment of the present invention.

### DETAILED DESCRIPTION OF THE INVENTION

First Embodiment

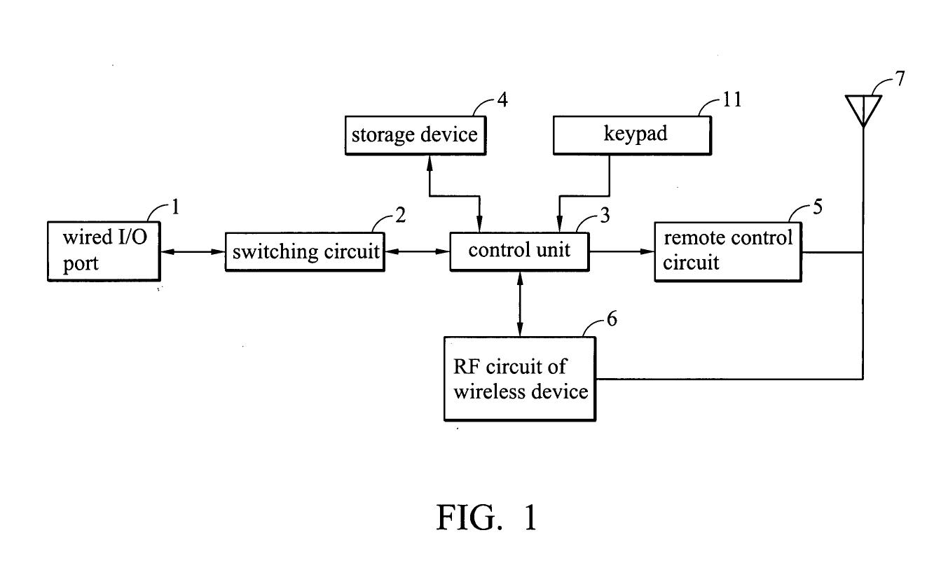

FIG. 1 is a schematic diagram of a wireless device with a remote control function according to the first embodiment of the present invention. As shown in FIG. 1, a switching circuit 2 is coupled with a wired I/O (Input/Output) port 1 for executing audio and data transmission. The control unit 3 stores the data in a storage device 4 and executes related control operations. A remote control circuit 5 coupled between the control unit 3 and an antenna 7 reads out the data, and converts the data into a wireless signal for transmission. A RF (Radio Frequency) circuit of wireless device 6 is coupled between the control unit 3 and the antenna 7 for executing wireless communication.

The operating mechanism of the wireless device with a remote control function is as follows. The switching circuit 2, coupled with the wired I/O port 1., selectively operating in an audio mode or a data mode for inputing/outputing from the wired port. When the wired I/O port 1 is in the audio mode, the control unit 3 controls audio to be transmitted through the RF circuit of wireless device 6 and the antenna 7. When the wired I/O port 1 is in the data mode, a set of control codes of an external electronic device is input through the wired I/O port 1 and stored in the storage device 4 by the control unit 3. As shown in FIG. 1, the wireless device further comprises a keypad 11 coupled with the control unit 3. When the wireless device executes the remote control function, the control unit 3 enables the keypad 11 to enter a remote control mode in which the set of control codes in the storage device 4 is read out by the control unit 3 and a plurality of keys of the keypad 11 respectively correspond to a plurality of remote control commands defined by the set of control codes. The set of control codes is transmitted to the remote control circuit 5 for conversion to a wireless signal to be transmitted to the external electronic device through the antenna 7. Thereby, the wireless device remotely controls the external electronic device by pressing the keys of the keypad 11. As most wireless devices, such as mobile phones and PDAs (Personal Digital Assistants), have a keypad, a control unit, a wired I/O port, and a RF transmission circuit, using the techniques disclosed in the present invention, they can be used to remotely control televisions, air conditioners, dehumidifiers, stereo systems, microwave ovens, and the like, replacing conventional remote controls.

Second Embodiment

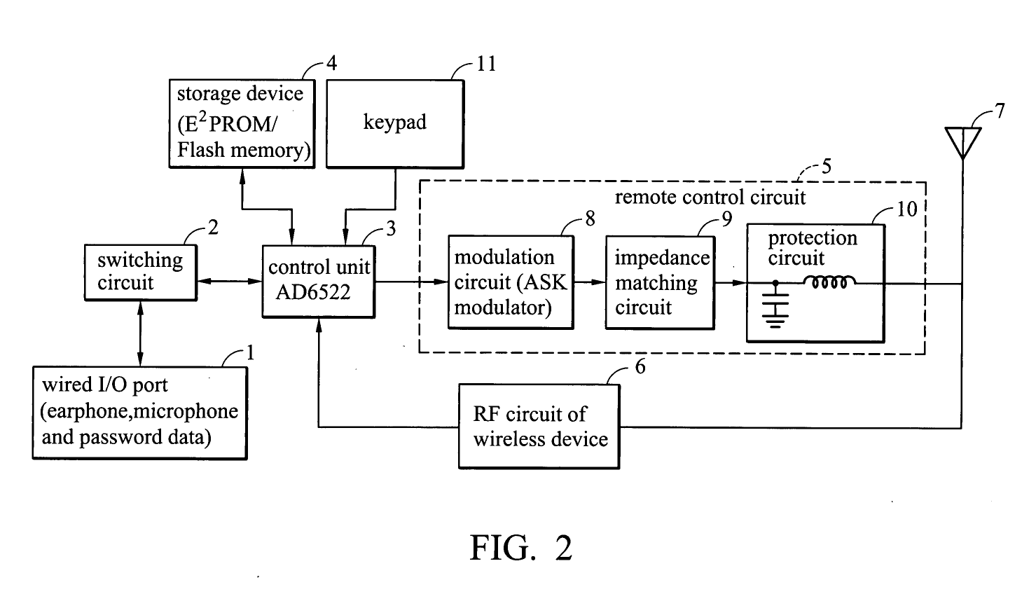

FIG. 2 is a schematic diagram of a wireless device with a remote control function according to the second embodiment of the present invention. The operating mechanism of the second embodiment is similar to that of the first embodiment as described above. The wired I/O port 1 is an earphone port or a microphone port. The control unit 3 is an AD6522 series IC (Integrated Circuit). The remote control circuit 5 comprises a modulation circuit 8, an impedance matching circuit 9, and a protection circuit 10. The modulation circuit 8 is an ASK (Amplitude Shift Keying) modulator. The storage device 4 is an E²PROM (Electrically Erasable Programmable Read-Only Memory) or a flash memory. As shown in FIG. 2, when the wired I/O port 1 is in the data mode, a set of control codes of an external electronic device is input through the wired I/O port 1 and stored in the storage device 4, the E²PROM or the flash memory, by the AD6522 control unit 3 by means of a software encoding method. When the wireless device executes the remote control function, the AD6522 control unit 3 reads out the set of control codes from the storage device 4, the E²PROM or the flash memory, to be transmitted to the remote control circuit 5. The modulation circuit 8 is coupled with the AD6522 control unit 3 for converting the set of control codes into a modulation signal to increase the range of signals. The impedance matching circuit 9 coupled with the modulation circuit 8 receives the modulation signal and executes an impedance matching operation for the transmission circuits, to reduce power consumption and reflectivity due to poor impedance matching between any two nodes of the transmission circuits. High reflectivity reduces fidelity in the modulation signal. Moreover, the protection circuit 10 is coupled between the impedance matching circuit 9 and an antenna 7 and isolates a RF signal transmitted from a RF circuit of wireless device 6, thus preventing damage to the remote control circuit 5 and the wireless device due to excess RF signal power. Using the protection circuit 10, the wireless device can precisely control the external electronic device.

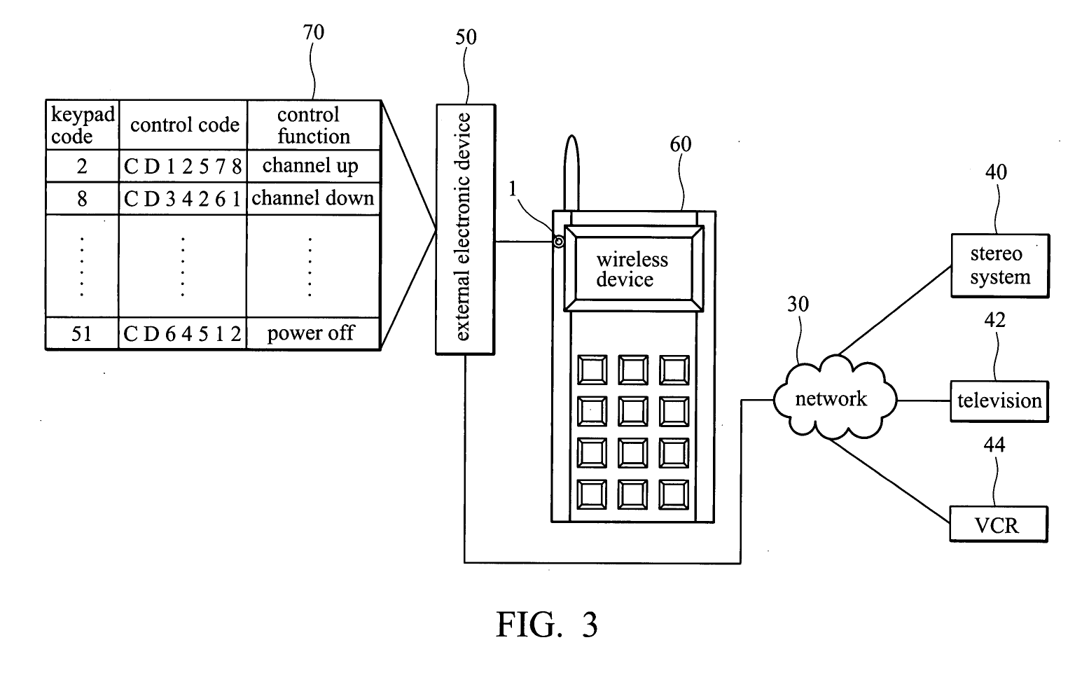

An example of the wireless device remotely controlling a television follows. FIG. 3 is a schematic diagram showing a control codes look-up table for a television controlled by a wireless device with a remote control function according to the second embodiment of the present invention. As shown in FIG. 3, a remote control of an external electronic device 50 is coupled with a wired I/O port 1 of a wireless device 60. The external electronic device 50 has an editable look-up table 70 of television control codes, wherein each row of the look-up table 70 comprises a keypad code, a control code, and a control function. When the wired I/O port 1 is in the data mode, the relationship of the keypad code and the control code in the look-up table 70 is transmitted to the wireless device 60 for storage. The external electronic device 50 is additionally coupled with a stereo system 40, the television 42, and a VCR 44 through a network 30. Thus, the relationship of the keypad code and the control code in the look-up table 70 can be transmitted through the network 30 to the stereo system 40, the television 42, and the VCR 44 for storage. Therefore, the keypad codes of the wireless device 60 correspond to the control functions of the television 42.

When a key on the wireless device 60 is pressed, a transmission signal corresponding to a control code is output. The television 42 receives the control code and executes the corresponding control function, thereby the wireless device 60 remotely controls the television 42. For example, when the key ‘8’ on the wireless device 60 is pressed, the corresponding control code ‘CD34261’ is transmitted wirelessly to the television 42. Thus, the television 42 executes the corresponding control function ‘channel down’.

In summary, the present invention has the following advantages. The wireless device of the present invention utilizes the switching circuit, coupled with the wired I/O port, to selectively operate in an audio mode or a data mode for inputing/outputing from the wired port. A set of control codes of an external electronic device input for storage in a storage device through the wired I/O port in the data mode is converted to a wireless signal by a remote control circuit for transmission in a remote control mode. Thus, the external electronic device can conventionally execute a remote control function.

Additionally, the wireless device of the present invention comprises principal circuits of a remote control and requires no additional hardware for executing remote control functions. The wireless device utilizes software, as well as a control unit, to accomplish the remote control function conventionally embodied by some circuits in a remote control, thus eliminating the need for multiple remote controls. Moreover, the wireless device can use its original antenna to work with the control unit.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A wireless device with a remote control function, for remotely controlling an electronic device, comprising:
a wired port;
a switching circuit coupled with the wired port and selectively operating in an audio mode or a data mode for inputing/outputing from the wired port;
a storage device storing a set of control codes transmitted from the switching circuit for remotely controlling the electronic device; and
a remote control circuit reading out the set of control codes and converting the set of control codes into a wireless signal and transmitting the wireless signal to the electronic device, thereby the wireless device remotely controls the electronic device.

2. The wireless device as claimed in claim 1, wherein the wired port is an earphone port or a microphone port.

3. The wireless device as claimed in claim 1, wherein the set of control codes is read out from a remote controller of the electronic device and input to the storage device for storage through the wired port when the switching circuit is in the data mode.

4. The wireless device as claimed in claim 1 further comprising a control unit storing the set of control codes into the storage device and reading out the set of control codes from the storage device and transmitting to the remote control circuit.

5. The wireless device as claimed in claim 4, wherein the control unit is an IC (Integrated Circuit) of the AD6522 series.

6. The wireless device as claimed in claim 4 further comprising an antenna, wherein the remote control circuit comprises:
a modulation circuit coupled with the control unit modulating the set of control codes; and
an impedance matching circuit coupled between the modulation circuit and the antenna adjusting output of the wireless signal.

7. The wireless device as claimed in claim 6, wherein the remote control circuit further comprises a protection circuit coupled between the antenna and the impedance matching circuit isolating a RF (Radio Frequency) signal transmitted from a RF circuit of the wireless device.

8. The wireless device as claimed in claim 4, wherein the control unit stores the set of control codes into the storage device by means of a software encoding method.

9. The wireless device as claimed in claim 1 further comprising a keypad coupled with the control unit, wherein when the wireless device executes the remote control function, the control unit enables the keypad to enter a remote control mode in which a plurality of keys of the keypad respectively correspond to a plurality of remote control commands defined by the set of control codes.

10. A wireless device, configured by a first electronic device to remotely control a second electronic device, comprising:
a wired port selectively connected with the first electronic device;
a switching circuit coupled with the wired port and selectively operating in an audio mode or a data mode for inputing/outputing from the wired port, the switching circuit receives a keypad code and a control code transmitted from the first electronic device, and wherein the control code corresponds to a control function of the second electronic device;
a storage device storing the keypad code and the control code; and
a keypad, wherein when the keypad code is input, the wireless device reads out the control code from the storage device and converts the control code into a wireless signal and transmitting the wireless signal to the second electronic device, thereby the second electronic device executes the control function.

11. The wireless device as claimed in claim 10, wherein the wired port is an earphone port or a microphone port.

12. The wireless device as claimed in claim 10, wherein the first electronic device is coupled with the second electronic device and transmits the control code and the control function to the second electronic device.

13. The wireless device with a remote control function as claimed in claim 10, wherein the first electronic device is coupled with the second electronic device through a network.

14. The wireless device as claimed in claim 10, wherein the first electronic device is a PC (Personal Computer).
